(19) United States
(12) Patent Application Publication
(10) Pub. No.: US 2013/0171912 A1
(43) Pub. Date: Jul. 4, 2013

(54) METHOD FOR PRODUCING PERIODIC TOOTH FLANK MODIFICATIONS, MACHINE TOOL, AND COMPUTER-READABLE MEDIUM

(71) Applicant: Stoyan Radev, Munchen (DE)

(72) Inventor: Stoyan Radev, Munchen (DE)

(21) Appl. No.: 13/808,559

(22) PCT Filed: Jul. 6, 2011
(86) PCT No.: PCT/EP2011/003353

§ 371 Date: Mar. 15, 2013

(30) Foreign Application Priority Data
Jul. 7, 2010 (DE) 10 2010 026 412.1

(51) Int. Cl. B23F 19/00; B24B 19/00

(52) U.S. Cl. CPC B23F 19/00; B24B 19/00
USPC 451/5; 451/47; 451/177

(57) ABSTRACT

The present invention relates to a method for producing periodic tooth flank modifications, wherein a tool is used during a first stroke carried out relative to a tooth flank of a tooth of a workpiece along an axis, which is rotated by a helix angle β relative to a center axis of the workpiece and which produces an enshrouding plane. The invention further relates to a machine tool, which is designed to carry out said method, and to a computer-readable medium having instructions, which lead to the open- or closed-loop control of a machine tool according to the method above when executed by a processor.

### FIELD OF THE INVENTION

The present invention relates to a method for producing periodic tooth flank modifications, wherein a tool is used during a first stroke carried out relative to a tooth flank of a tooth of a workpiece along an axis, which is rotated by a helix angle β relative to a center axis of the workpiece and which produces an enshrouding plane.

Nowadays, the noise behavior of gear mechanisms becomes increasingly important as part of the increasing environmental awareness. The limit values for the admissible noise emission are determined by customer requests on the one hand and by legal provisions on the other. This applies to the field of industrial use as well as to private use. Since gear pairings and/or tooth meshing constitute(s) one of the most important sources of noise in gear mechanisms, the endeavor to achieve in this respect structural improvements as well as improvements in the field of manufacturing technology is understandable. One possibility of effectively reducing the excitation of vibrations and noise of a gear pairing, and, consequently, the emission of noise from a gear mechanism is the use of tooth flank modification. Such tooth flank modifications are also referred to as flank corrections.

Periodic tooth flank modifications and/or periodic excitation corrections represent a special solution allowing a complete elimination of gear excitation of a spur gear pairing under a given design load, a wide load range around the design load being additionally improved to a significant extent.

This kind of tooth flank modification additionally allows a separate optimization of the load bearing capacity of the given spur gear pairing as well as the processing of individual harmonic components of the excitation function of tooth meshing, if they have a sinusoidal shape.

Relevant prior art is known from the dissertation “Einfluss von Flankenkorrekturen auf das Anregungsverhalten gerad- and schragverzahnter Stirnradpaarungen” (“Influence of flank corrections on the excitation behavior of straight and helical-toothed spur gear pairings”). This dissertation was submitted to the Technical University of Munich on Dec. 6, 2006, and accepted by the Mechanical Engineering Department on Jun. 20, 2007. It can be retrieved under the URN number “um:nbn:de:bvb:91-diss-20080122-645505-1-7” on the server of the German National Library under http://deposit.ddb.de/. With respect to the zone of action, a periodic tooth flank modification, which, as has already been stated hereinbefore, is also referred to as periodic excitation correction, is unequivocally described by the values amplitude, period, phase length and orientation, in the case of a sinusoidal shape and a given design load. The amplitude depends on the given macro- and microgeometry of the toothing and the harmonic component of the excitation function of the tooth meshing to be processed. The period only depends on the harmonic component of the tooth meshing to be processed and has a length that is equal to the length of the base pith for the basic harmonic and a length that is equal to the length of the whole divisor of the base pith for the respective higher harmonic components. Each harmonic component of the excitation function of the tooth meshing has a phasing of its own, which additionally depends on the macro- and microgeometry of the toothing. The orientation of the periodic tooth flank modification corresponds to the so-called helix angle at the so-called base circle.

One characteristic of periodic tooth flank modification is that each individual contact line includes a specific correction amount, i.e. all the points of a given contact line are displaced by the same amount, which may also be zero, in the normal direction with respect to the plane of action.

At present, periodic tooth flank modifications are produced with the aid of topological processes in individual pilot and research projects. In this respect, DE 2307493 C is referred to by way of example.

It has, however, turned out that such topological processes are not economic and that they are difficult to reproduce. Hence, a method is needed, which is economic and adapted to be used in a reproducible manner on a larger scale.

It is moreover very complicated to create adequate programs, which allow topological processing. Also the methods known from the prior art according to DE 3734828 C1, DE 10208531 B4 and DE 4112122 C3 suffer from these two drawbacks. The alternative methods known from EP 0074930 A2, EP 0180747 A2 and EP 0132582 A1 already represent a certain improvement, but they do not yet lead to the desired result.

Gear cutting processes for cylindrical gears, e.g. forming and rolling-type processes, are known to a sufficient extent. In the case of all rolling-type processes, the workpiece and the tool carry out a rolling movement. They roll on one another like two toothed gear unit elements. During this rolling contact the involute is enshrouded by a tool having a straight reference profile, with simultaneous movement of the workpiece. At any position, the cutting edges are tangent on an involute profile so that the tooth flank is created from a sequence of profiling cuts. A continuous method known as hobbing has the advantage that a great cutting rate is accomplished in the case of broad gears. The enveloping body of the hob is a cylindrical involute worm. The tool and the workpiece rotate during the rolling movement. The cutting movement is executed by the rotating cutter. For producing spur gears, the cutter and the workpiece are displaced relative to one another in the direction of the workpiece axis, i.e. here in the direction of a center axis, and the rolling movement is executed simultaneously. Hobbing is frequently used for preliminary gear cutting of gears in series production. In addition, this method is used for preliminary gear cutting and finishing gear cutting of workpieces with soft, tempered and hardened large tooth profiles, special tooth profiles and spline profiles. However, this method turned out to be disadvantageous insofar as it entails a long leading slope and runout as well as the impossibility of producing internal teeth.

Another method known is gear shaping, which is also classified as a continuous rolling-type process. During gear cutting, the cutting wheel and the workpiece roll on one another like the gear and the mating gear of a spur gear unit. Simultaneously, the cutting wheel executes the cutting movement through its reciprocating movement. In the case of straight teeth, the reciprocating movement takes place in the axial direction of the workpiece. In the case of a helical gearing, the helical-toothed cutting wheel executes a helical cutting movement corresponding to the helix angle β to be produced. The result is a straight-toothed spur gear or a helical-toothed spur gear whose flanks taper to the rear. This results in the formation of the clearance angle which is necessary for the cutting operation. Such gear shaping is used for forming straight and helical inner and outer teeth on workpieces. Also a very small runout is accomplished as an advantage, an idle stroke being, however, carried out. For right and left tooth slopes, different tool guide paths and tools must be used. This is particularly disadvantageous. When the alternative generating planing is used, which is an indexing generation method, it will, moreover, be impossible to produce internal teeth and it will be necessary to accept the drawback of an idle stroke. Although a simple inexpensive tool, small leading slopes and a precise flank shape are realizable, these advantages are not able to compensate the disadvantages to a sufficient extent. The workpiece on which the teeth are to be formed rolls on the rack-type cutter, i.e. on the planing tool, in the case of this method. The cutting movement, i.e. a vertical movement, is executed by the tool. The rack-type cutter is lifted during the return stroke. When the cutting of one tooth has been finished, the workpiece is rotated by one tooth pitch. The tool is here a rack whose flanks are cut free to the rear. The latter are referred to as rack-type cutter.

When form milling is used as an alternative, the cutter has the profile of the tooth space to be cut. The rotating cutter and the workpiece are displaced relative to one another in the direction of the workpiece axis. When straight teeth are formed, the workpiece does not rotate. Only when a tooth space has been finished, the gear which is being produced is advanced by one pitch. In the case of helical teeth, the workpiece carries out a continuous rotation, which corresponds to the helix angle β. Also in this case partitioning is carried out in a single partitioning method. Form milling can be executed by means of end mills or by means of side milling cutters. It is true that this method allows the advantageous use of inexpensive tools which are easy to dress, but different roll curves are required for different involute curvatures.

For accomplishing a tooth flank modification, the so-called generation grinding is an obvious method to use. When this method is used, the involute profile is created by moving the gear between two disk grinding wheels in rolling contact therewith. This includes the use of templates, or the use of an adequate control. Topological grinding is, in the final analysis, carried out with the aid of the so-called 0°-method or the Niles method.

The grinding wheels are—for example in the case of a so-called 0°-method—arranged in parallel. The grinding feed in the axial direction is carried out by the workpiece. It is reciprocated in the axial direction. Partitioning is executed at the end of the feed path. In each work cycle two tooth flanks are guided simultaneously. Feeding is effected by moving the grinding wheels towards one another. Also this method entails the drawback that different roll curves for the tool must be held available.

From a present-day perspective, topological grinding cannot be carried out by means of a profile grinding method. Making use of a generation grinding method this would, however, be possible, provided that a point contact or an approximate point contact can be established between workpiece and tool.

Accomplishing topological grinding is, however, difficult when a continuous generation grinding method is used, since a plurality of teeth of the worm grinding wheel are in mesh with a plurality of teeth of the workpiece. Making use of the α°-method, topological grinding is theoretically impossible, since a point contact does not exist. In the case of the 0°-method and/or Niles method (indexing generation grinding with a conical grinding wheel) an (approximate) point contact and, consequently, a topological grinding process can be realized.

Whenever topological grinding is realized, it has hitherto been necessary to provide a complicated control. In addition, a plurality of movable axes exist while the workpiece is being machined. However, the higher the number of moving axes is, the higher the error rate will be.

It is therefore the object of the present invention to achieve a better tooth flank modification with the aid of simple means.

According to the present invention, this is accomplished by a method according to claim 1, a machine tool according to claim 8 and a computer-readable medium according to claim 9.

The object is achieved in that the enshrouding plane is oriented orthogonally to a plane of action so that during the first stroke a machining track is created exactly along a first contact line for a first corresponding rolling position by means of the machining effect of the tool on the workpiece, wherein the first contact line preferably forms simultaneously a second contact line corresponding to the first contact line between the workpiece and any rolling partner of the same helix angle β, wherein furthermore the tooth flank modification is created by means of an advancement by the value zu of the tool in the normal direction of the tool and/or of the workpiece along the first contact line and the workpiece performs no rolling motion during the individual stroke.

In this way, a larger or smaller removal of material from the workpiece is caused along the first contact line, and tooth flank modification is accomplished for a first position between the workpiece and an arbitrary rolling partner of the same helix angle. This realization is extremely simple and allows high precision values. Surprisingly enough, this amazingly simple solution has therefore solved the task.

The task is also solved by a machine tool, which is configured such that it carries out the method. Also a computer-readable medium having instructions, which, when executed by a processor, lead to an open- or closed-loop control of a machine tool according to this method solves this task.

By means of a reasonable outlay and simple kinematics, a periodic tooth flank modification is accomplished so as to achieve a minimization of the noise caused by spur gear pairs. With extremely small amplitudes, the method is only limited by the precision of the machine tool used.

Such a method produces periodic tooth flank modifications much faster, with much higher accuracy and with a much higher degree of reproducibility than the existing methods. It can also be realized with a much smaller investment in programming and control technology in comparison with topological grinding, since it is not based on a point contact but on an enshrouding plane. Other than in the case of topological grinding, this method can be realized on the basis of continuous generation grinding and the α°-method.

Advantageous embodiments are claimed in the subclaims and will be explained in more detail in the following.

It is e.g. of advantage when the value zu remains unchanged during an individual stroke. Thus, the same modification value can be accomplished along the whole contact line, and this will lead to a slightly higher or slightly lower first contact line in comparison with a second contact line extending beside the first contact line. Of course, the value zu may vary also along the first contact line or the subsequent contact lines.

When, after finishing the first tooth flank modification by the first stroke exactly on the first contact line, a second stroke is carried out exactly on a third contact line so as to create a second tooth flank modification, said third contact line corresponding to a fourth contact line between the workpiece and any rolling partner of the same helix angle β at a second discrete rolling position, it is thus possible to process subsequently the whole tooth flank width.

It will be of advantage when the workpiece is formed as a straight- or helical-toothed component. Particularly good degrees of efficiency can be obtained in this way.

Conventional cost-saving machine tools can be used, when the method used is a machining process.

Particularly precise methods make use of geometrically defined or undefined tools, which is of advantage when such methods are used.

In order to achieve a particularly good quality, it will be of advantage when one or a plurality of conical grinding wheels and/or one or a plurality of worm grinding wheels and/or one or a plurality of disk grinding wheels are used.

Furthermore, it will be of advantage when the workpiece is formed as an internally-toothed or an externally-toothed component.

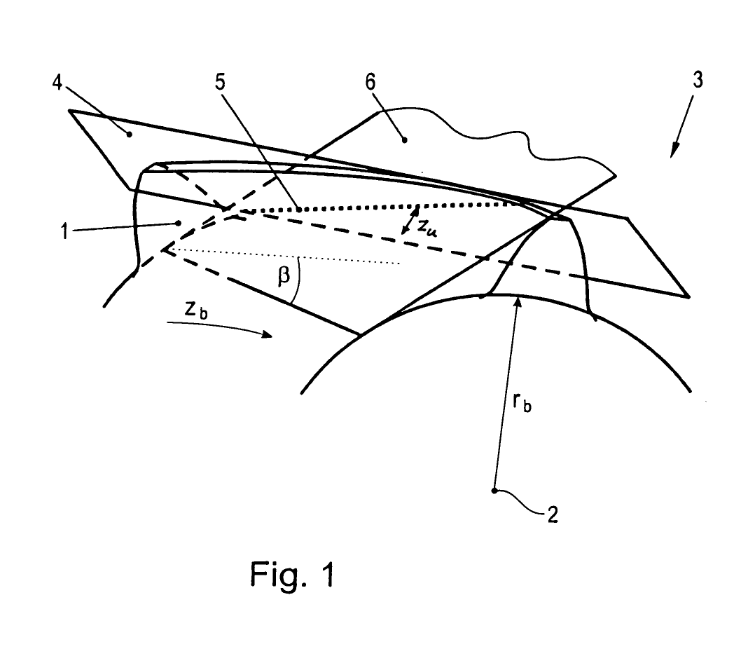

In the following, the invention will be explained in more detail with the aid of a drawing, in which the only FIGURE, viz. FIG. 1, shows an engagement situation between a tooth flank of a tooth of a workpiece and a tool envelope for an individual discrete engagement position, i.e. rolling position. The tool envelope is a plane in FIG. 1.

The easiest way for picturing in the mind the mode of operation of the method is obviously to start from a tool having a profile which is similar or equal to the standard profile according to DIN 3972, i.e. a tool having straight flanks and an angle of inclination of the flanks that corresponds to the normal pressure angle α.

When this tool is brought into normal engagement with a flank of a tooth 1 at an arbitrary position of engagement, and brought in contact in the width direction zb along an axis by a helix angle β relative to a center axis 2 of a workpiece 3 configured as a gear and rotated in the tooth width direction zb and displaced along an axis extending in a plane that is orthogonal to the standard profile, an enshrouding plane 4 of the tool flank is produced.

During this stroke, the point of contact between the tool and the tooth flank moves exactly along a contact line 5. That this first contact line 5 also represents a second contact line between the tooth flank shown and the tooth flank of any partner of the same helix angle β is easy to understand. These facts are also illustrated by a plane of action 6 which is tangent to the base circle cylinder in FIG. 1 and in which the first contact line 5 extends. With the aid of a suitable tool, which produces an enshrouding plane in the plane 4, it is thus possible to create in the case of a given rolling position the resultant stroke between the tool and the workpiece 3, exactly a single contact line, which is here the first contact line 5, by a simple, relative linear movement. The machining track is thus located exactly on the first contact line 5.

The amount of tooth flank modification, i.e. the correction accomplished, for this first contact line 5 can be determined by the advancement in the normal direction between tool and workpiece 3. By rotating the workpiece 3 between the individual strokes, it is thus possible to process step-by-step the neighbouring contact lines, i.e. the third contact line as the next one, in each rolling position individually. It should here be taken into account that the shape of the tooth flank modification in the profile direction may perhaps not be represented precisely, but as a polygonal line, so that the accuracy of the method depends on the number of discrete rolling positions processed. When a section is made along the center axis 2 of the tooth width direction zb, a polygonal line can be seen on the surface of the tooth flank.

The method described here can be realized in a particularly advantageous manner via all rolling-type processes. For reasons of accuracy, hard fine machining processes are more suitable. Particularly simple possibilities of using the method are indexing generation grinding with a conical grinding wheel, indexing generation grinding with a disk grinding wheel in an α°-process, and generation grinding with a worm grinding wheel. As regards generation grinding with a worm grinding wheel, reference should be made to the fact that, depending on the workpiece geometry and the tool geometry, it is also possible to process a plurality of teeth 1 of the workpiece 3 simultaneously, so that the periodic tooth flank modifications will be of a partition periodic nature.

### LIST OF REFERENCE NUMERALS

1 tooth
2 center axis
3 workpiece
4 enshrouding plane
5 contact line
6 plane of action
zᵤ advancement value
z_{b} tooth width direction
r_{b} base circle radius
β helix angle

1. A method for producing periodic tooth flank modifications, wherein a tool is used during a first stroke carried out relative to a tooth flank of a tooth (1) of a workpiece (3) along an axis, which is rotated by a helix angle β relative to a center axis (2) of the workpiece (3) and which produces an enshrouding plane (4), wherein the enshrouding plane (4) is oriented orthogonally to a plane of action (6) so that during the first stroke a machining track is created exactly along a first contact line (5) for a first corresponding rolling position by means of the machining effect of the tool on the workpiece (3), wherein furthermore the tooth flank modification is created by means of an advancement by the value (zᵤ) of the tool in the normal direction of the tool and of the workpiece (3) along the first contact line (5) and the workpiece (3) performs no rolling motion during the individual stroke.

2. The method according to claim 1, characterized in that the value (zᵤ) remains unchanged during an individual stroke.

3. The method according to claim 1, characterized in that, after finishing the first tooth flank modification by the first stroke exactly on the first contact line (5), a second stroke is carried out exactly on a third contact line so as to create a second tooth flank modification, said third contact line corresponding to a fourth contact line between the workpiece and any rolling partner of the same helix angle (β) at a second discrete rolling position.

4. The method according to claim 1, characterized in that the workpiece (3) is formed as a straight- or helical-toothed component.

5. The method according to claim 1, characterized in that the method used is a machining process.

6. The method according claim 5, characterized in that one or a plurality of conical grinding wheels and/or one or a plurality of worm grinding wheels and/or one or a plurality of disk grinding wheels are used.

7. The method according to claim 1, characterized in that the first contact line (5) simultaneously forms a second contact line corresponding to the first contact line (5) between the workpiece (3) and any rolling partner of the same helix angle (β).

8. A machine tool, which is designed to carry out the method according to claim 1.

9. A computer-readable medium having instructions, which, when executed by a processor, lead to an open- or closed-loop control of a machine tool according to the method disclosed in claim 1.
